(19) United States
(12) Patent Application Publication
(10) Pub. No.: US 2005/0172531 A1
(43) Pub. Date: Aug. 11, 2005

(54) Display frame

(76) Inventor: Michael Doctoroff, (US)

Correspondence Address: JOHN E. TOUPAL, 116 CONCORD STREET, FRAMINGHAM, MA, 01701, US

(21) Appl. No.: 10/775,990

(22) Filed: Feb. 11, 2004

(51) Int. Cl. G09F 3/18

(52) U.S. Cl. 40/661

(57) ABSTRACT

A frame including a first sheet member having a transparent top wall portion with an inner top wall surface and an outer top wall surface defined by rectilinear connected edges and a top side wall portion aligned with each of the rectilinear connected edges other than a particular one thereof. Also included is a second sheet member having a bottom wall portion with an inner bottom wall surface and an outer bottom wall surface defined by rectilinear joined edges extending parallel to the connected edges, and a bottom sidewall portion extending outwardly from said inner bottom wall surface and disposed parallel to and inwardly laterally adjacent to each of the top side wall portions so as to form between the inner top wall surface and the inner bottom wall surface a closed cavity accessible through an opening adjacent to the particular connected edge.

### FIELD OF THE INVENTION

The invention relates generally to a frame and, more particularly, to an assembly of molded plastic transparent sheets for sandwiching a sign, photograph, display or the like.

### BACKGROUND OF THE INVENTION

Frames made of transparent plastic sheets for retaining display sheets are well known. Examples of such a frame are disclosed, for example only, in U.S. Pat. Nos. 4,726,132 and 5,058,300 Also known is a frame consisting of thin transparent sheets secured together along three inner marginal edges with spacer elements creating between the sheets a cavity for receiving a display sheet. Disadvantages of such a frame include high assembly costs and reduced display area because of the marginal regions occupied by the spacer elements. The object of this invention, therefore, is to provide an improved plastic sheet frame assembly.

### SUMMARY OF THE INVENTION

The invention is a frame including a first sheet member having a transparent top wall portion with an inner top wall surface and an outer top wall surface defined by rectilinear connected edges, and a top side wall portion aligned with each of the rectilinear connected edges other than a particular one thereof. Also included is a second sheet member having a bottom wall portion with an inner bottom wall surface and an outer bottom wall surface defined by rectilinear joined edges extending parallel to the connected edges, and a bottom sidewall portion extending outwardly from said inner bottom wall surface and disposed parallel to and inwardly laterally adjacent to each of the top side wall portions so as to form between the inner top wall surface and the inner bottom wall surface a closed cavity accessible through an opening adjacent to the particular connected edge. After insertion through the opening of a display sheet, the frame can be mounted in a suitable location.

According to one feature of the invention, external surfaces of the bottom side wall portions engage internal surfaces of the top side wall portions and outer edges of the bottom side wall portions engage the inner top wall surface. The engaged surfaces form a compact stable frame.

According to another feature, the invention includes an attachment mechanism permanently securing the first sheet member to the second sheet member. The attachment mechanism preferably consists of welds formed between the top and bottom side wall portions and between the bottom side wall portions and the inner top wall surface. The attachment mechanism further enhances frame stability.

According to yet another feature of the invention, the total width of the second sheet member between outer edges of the bottom side wall portions and the outer bottom wall surface is substantially equal to a uniform length of the top side wall portions. This feature contributes to the creation of a smooth frame profile.

According to still other features, the total thickness of the frame between the outer top wall surface and the outer bottom wall surface is less than 0.06 inches and the top wall portion is rectangular. These features provide a highly compact frame for displaying popular rectangular display sheets.

According to further features of the invention, the width W of the first sheet member between internal surfaces of a parallel pair of the top wall portions is equal to the total width W of the second sheet member between external surfaces of a parallel pair of the bottom side wall portions; and the length L of the first sheet member between the particular connected edge and an internal surface of the top wall portion parallel thereto is equal to a total length L of the second sheet member between joined edges thereof lying parallel to the particular connected edge. These features further contribute to a smooth frame profile.

### DESCRIPTION OF THE DRAWINGS

These and other objects and features of the invention will become more apparent upon a perusal of the following description taken in conjunction with the accompanying drawings wherein:

FIG. 1 is a top perspective view of a preferred frame embodiment of the invention;

FIG. 2 is an exploded partially cut-away perspective view of the frame shown in FIG. 1;

FIG. 3 is a partially cut-away, top perspective view of the frame shown in FIG. 1;

FIG. 4 is a cross-sectional view taken along lines 4-4 of FIG. 2;

FIG. 5 is a cross-sectional view taken along lines 5-5 of FIG. 3;

FIG. 6 is a partially cut-away top view of the frame shown in FIG. 1; and

FIG. 7 is a partially cut-away bottom view of the frame shown in FIG. 1.

### DESCRIPTION OF THE PREFERRED EMBODIMENT

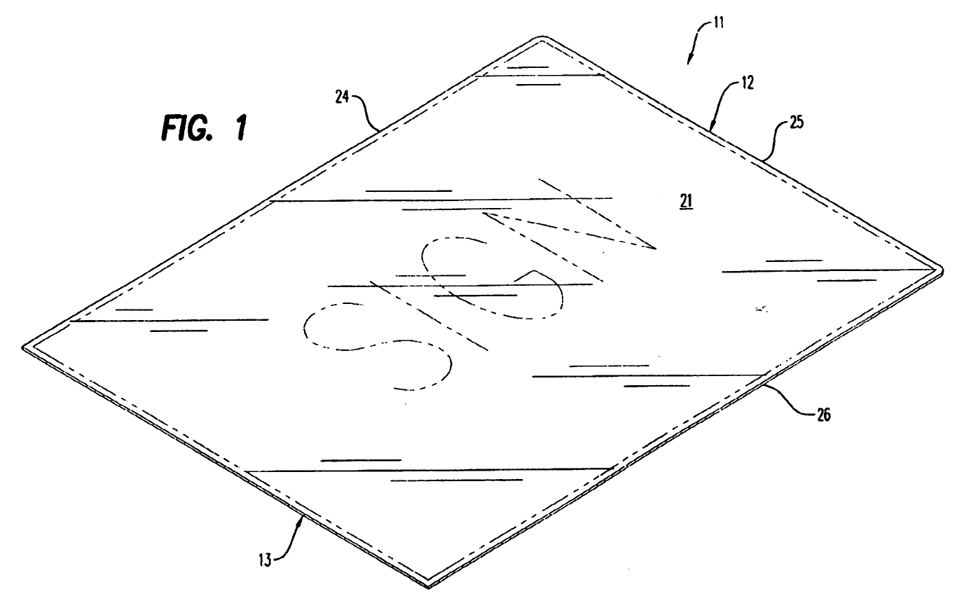

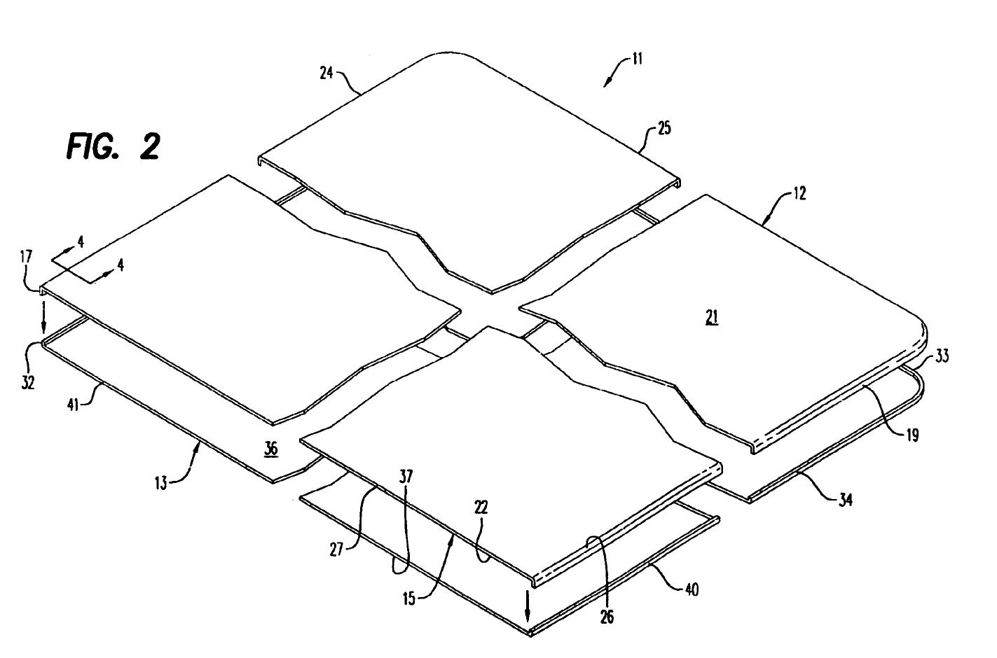

A frame 11 is provided by the assembly of a first sheet member 12 and a second sheet member 13 as shown in FIG. 1. Forming the first sheet member 12 is a top wall portion 15 and a plurality of top side wall portions 17-19. The top wall portion 15 has a rectangular inner top wall surface 21 and a rectangular outer top wall surface 22 defined by rectilinear connected edges 24-27. As illustrated in FIGS. 2-5, the side wall portions 17-19 extend outwardly from the inner top wall surface 22 and one of the side wall portions 17-19 is aligned with each of the connected edges 24-26 except one particular edge 27.

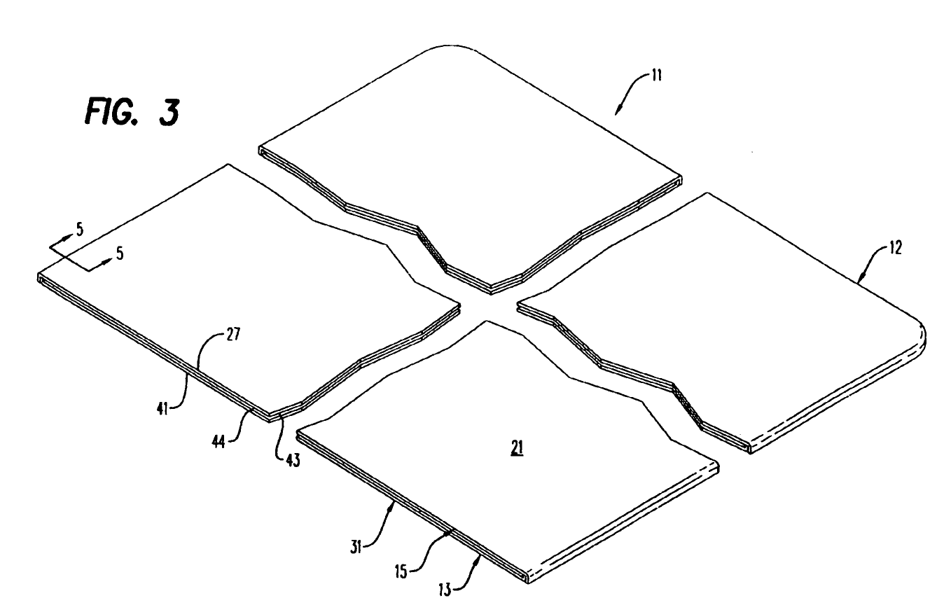

The second sheet member 13 is formed by a bottom wall portion 31 and a plurality of bottom side wall portions 32-34. Defining the bottom wall portion 31 are a rectangular inner bottom wall surface 36 and a rectangular outer bottom wall surface 37 having rectilinear joined edges 38-41 lying parallel to the connected edges 24-27. The bottom side wall portions 32-34 are disposed parallel to and inwardly laterally adjacent to the top side wall portions 17-19 as depicted in FIG. 5 so as to form between the inner top wall surface 22 and the inner bottom wall surface 36 a closed cavity 43 accessible only through an opening 44 (FIG. 3) formed by the absence of top and bottom side wall portions adjacent to the particular connected edge 27.

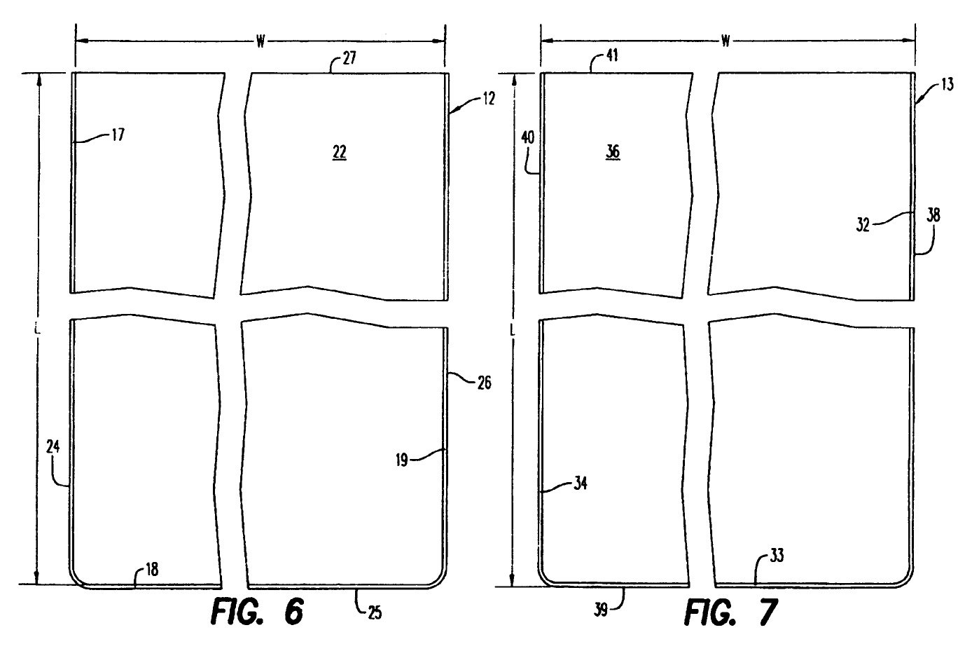

As illustrated in FIGS. 5-7, external surfaces 46 of the bottom sidewall portions 32-34 engage internal surfaces 47 of the top side wall portions 17-19 and outer edges 48 of the bottom side wall portions 32-34 engage the inner top wall surface 22. Preferably, the first sheet member 12 is permanently secured to the second sheet member 13 by a suitable attachment mechanism. For example, in the preferred embodiment a chemical weld is created between the external surfaces 46 of the bottom side wall portions 32-34, and the iternal surfaces 47 of the top side wall portions 17-19, and between the outer edges 48 of the bottom side wall portions 32-34 and the inner top wall surface 22.

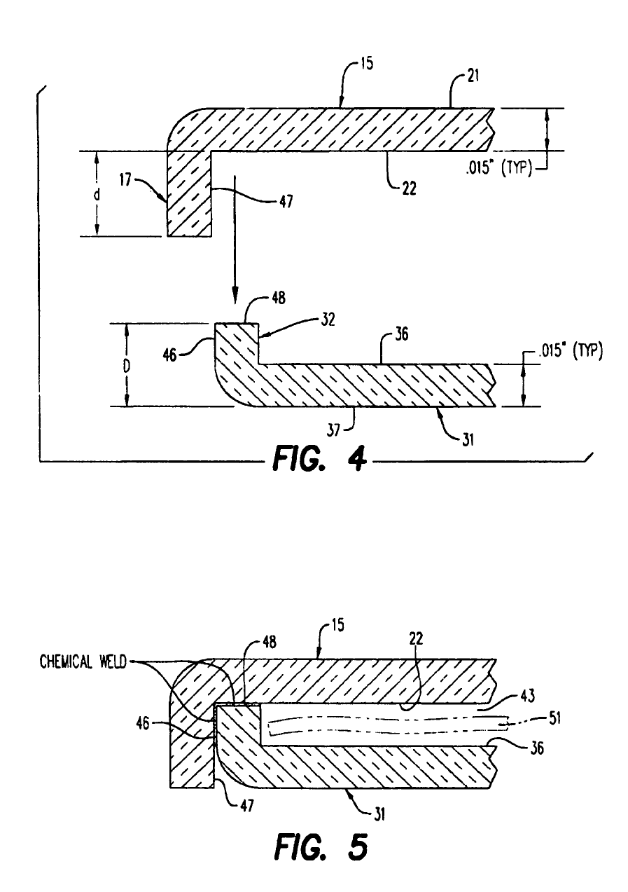

The preferred embodiment has dimensional features which provide desirable stiffness, minimize material and assembly costs, and establish for the frame 11 a compact, smooth profile without unnecessary exposed edges and protrusions. In that regard, and as shown in FIGS. 4, 6, and 7, the total thickness D of the second sheet member 13 between the outer edges of the bottom side wall portions 32-34 and the outer bottom wall surface 37 is equal to the uniform lengths d of the top side wall portions 17-19; the width W of the first sheet member 12 between internal surfaces 47 of the parallel top wall portions 17, 19 is equal to the total width W of the second sheet member 13 between external surfaces 46 of the parallel bottom side wall portions 32, 34; and the length L of the first sheet member 12 between the particular edge 27 and the internal surface of the top side wall portion 18 is equal to the total length L of the second sheet member 13 between the edges 39, 41. In addition, the total thickness of the frame 11 between the outer top wall surface 21 and the outer bottom wall surface 37 preferably is less than 0.06 inches.

During use of the frame, a sign, photograph, or the like 51 is inserted through the opening 44 into the cavity 43 as illustrated in FIG. 5. In that position, the sign 51 is visible through the transparent top wall portion of the first sheet member 12. The frame 11 then can be mounted conveniently in any desired location such as on a wall, bulletin board, table or the like.

Obviously, many modifications and variations of the present invention are possible in light of the above teaching. It is to be understood, therefore, that the invention can be practiced otherwise than as specifically described.

1. A frame comprising:
a first sheet member including a transparent top wall portion having an inner top wall surface and an outer top wall surface defined by connected edges, and a top side wall portion aligned with each of said connected edges other than a particular one thereof; said side wall portions extending outwardly from said inner top wall surface; and
a second sheet member including a bottom wall portion having an inner bottom wall surface and an outer bottom wall surface defined by joined edges extending parallel to said connected edges, and a bottom sidewall portion extending outwardly from said inner bottom wall surface and disposed substantially parallel to and inwardly laterally adjacent to each of said top side wall portions so as to form between said inner top wall surface and said inner bottom wall surface a substantially closed cavity accessible through an opening adjacent to said particular connected edge.

2. A frame according to claim 1 wherein external surfaces of said bottom side wall portions engage internal surfaces of said top side wall portions.

3. A frame according to claim 2 wherein outer edges of said bottom side wall portions engage said inner top wall surface.

4. A frame according to claim 3 including an attachment mechanism permanently securing said first sheet member to said second sheet member.

5. A frame according to claim 4 wherein said attachment mechanism comprises welds formed between said top and bottom side wall portions and between said bottom side wall portions and said inner top wall surface.

6. A frame according to claim 5 wherein the total width of said second sheet member between outer edges of said bottom side wall portions and said outer bottom wall surface is substantially equal to a uniform length of said top side wall portions.

7. A frame according to claim 1 including an attachment mechanism permanently securing said front sheet member to said second sheet member.

8. A frame according to claim 7 wherein said attachment mechanism comprises welds formed between said top and bottom side wall portions and between said bottom side wall portions and said inner top wall surface.

9. A frame according to claim 8 wherein the total width of said second sheet member between outer edges of said bottom side wall portions and said outer bottom wall surface is substantially equal to a uniform length of said top side wall portions.

10. A frame according to claim 9 wherein the total thickness of said sign holder between said outer top wall surface and said outer bottom wall surface is less than 0.06 inches.

11. A frame according to claim 1 wherein said top wall portion is rectangular.

12. A frame according to claim 11 wherein external surfaces of said bottom side wall portions engage internal surfaces of top side wall portions.

13. A frame according to claim 12 wherein outer edges of said bottom side wall portions engage said inner top wall surface.

14. A frame according to claim 13 including an attachment mechanism permanently securing said first sheet member to said second sheet member.

15. A frame according to claim 14 wherein said attachment mechanism comprises welds formed between said top and bottom side wall portions and between said bottom side wall portions and said inner top wall surface.

16. A frame according to claim 15 wherein the total width of said second sheet member between outer edges of said bottom side wall portions and said outer bottom wall surface is substantially equal to a uniform length of said top side wall portions.

17. A frame according to claim 11 including an attachment mechanism permanently securing said first sheet member to said second sheet member.

18. A frame according to claim 17 wherein said attachment mechanism comprises welds formed between said top and bottom side wall portions and between said bottom side wall portions and said inner top wall surface.

19. A frame according to claim 18 wherein the total width of said second sheet member between outer edges of said bottom side wall portions and said outer bottom wall surface is substantially equal to a uniform length of said top side wall portions.

20. A frame according to claim 19 wherein the width W of said first sheet member between internal surfaces of a parallel pair of said top wall portions is equal to the total width W of the second sheet member between external surfaces of a parallel pair of said bottom side wall portions.

21. A frame according to claim 20 wherein the length L of said first sheet member between said particular connected edge and an internal surface of a said top wall portion parallel thereto is equal to a total length L of said second sheet member between joined edges thereof lying parallel to said particular connected edge.
